(19) United States
(12) Patent Application Publication
(10) Pub. No.: US 2005/0140104 A1
(43) Pub. Date: Jun. 30, 2005

(54) Portable casing

(76) Inventors: Francis Pan, Taichung (TW); John C. Pan, Taichung (TW); Hung-Lung Uen, Taichung (TW); Shih-Huang Chu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/743,774

(22) Filed: Dec. 24, 2003

(51) Int. Cl. B62B 1/00

(52) U.S. Cl. 280/47.131

(57) ABSTRACT

A casing has a hollow body, at least one wheel holder and at least one wheel. The body has at least one cavity to respectively receive the at least one wheel holder. Each wheel is rotatably mounted on one of the at least one wheel holder. With the arrangement of the at least one wheel, the casing can be transported conveniently and easily.

### BACKGROUND OF THE INVENTION

1. Field of the Invention

The present invention relates to a casing, and more particularly to a casing that has at least one wheel and is conveniently moved and transported.

2. Description of Related Art

To conveniently transport objects, casings, such as paper casings are commonly used to package objects therein. However, a casing with an object contained therein has a heavy weight for manual transportation, and this makes the conventional casing inconvenient to transport.

To overcome the shortcomings, the present invention tends to provide a casing to mitigate or obviate the aforementioned problems.

### SUMMARY OF THE INVENTION

The main objective of the invention is to provide a casing that has at least one wheel and can be transported conveniently and easily. The casing has a hollow body, at least one wheel holder and at least one wheel. The body has at least one cavity to respectively receive the at least one wheel holder. Each wheel is rotatably mounted on the at least one wheel holder.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a casing in accordance with the present invention;

FIG. 2 is a side plan view in partial section of the casing in FIG. 1;

FIG. 3 is an operational side plan view in partial section of the casing in FIG. 1;

FIG. 4 is an exploded perspective view of a second embodiment of a casing in accordance with the present invention;

FIG. 5 is a perspective view of a third embodiment of a casing in accordance with the present invention;

FIG. 6 is an operational side plan view in partial section of the casing in FIG. 5;

FIG. 7 is a perspective view of a fourth-embodiment of a casing in accordance with the present invention;

FIG. 8 is a perspective view of a fifth embodiment of a casing in accordance with the present invention; and

FIG. 9 is an operational side plan view in partial section of the casing in FIG. 8.

### DETAILED DESCRIPTION OF PREFERRED EMBODIMENT

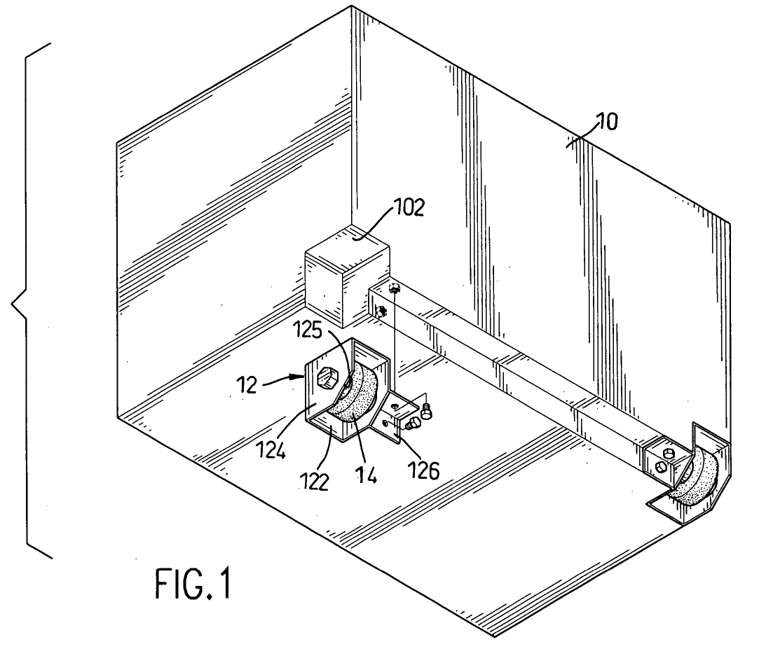

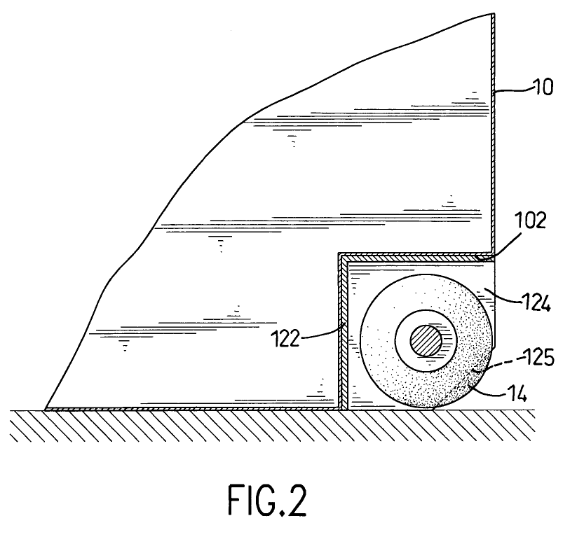

With reference to FIGS. 1 and 2, a first embodiment of a casing in accordance with the present invention comprises a hollow body (10), two wheel holders (12) and two wheels (14). The hollow body (10) has two cavities (102) defined in bottom of the body (10) at two adjacent corners respectively. The wheel holders (12) are securely mounted respectively in the cavities (102). In the first embodiment, each wheel holder (12) has an L-shaped base (122) with two sides and two wings (124) extending from the sides of the base (122) to define a space in the wheel holder (12). Each wheel (14) is rotatably mounted in the space in one of the wheel holders (12) with an axle and is partially exposed from the corresponding wheel holder (12). In an optional embodiment, each wing (124) has a cutout (125) to make the wheel exposed from the corresponding wheel holder (12). In addition, an L-shaped securing frame (126) extends from one of the wings (124) on each wheel holder (12) and is securely attached to the body (10) through fasteners (not numbered). Accordingly, each wheel holder (12) can be securely mounted on the body (10) through the securing frame (126) and the fasteners. In an alternative embodiment, each wheel holder (12) can be securely mounted in the corresponding cavity (102) with glue.

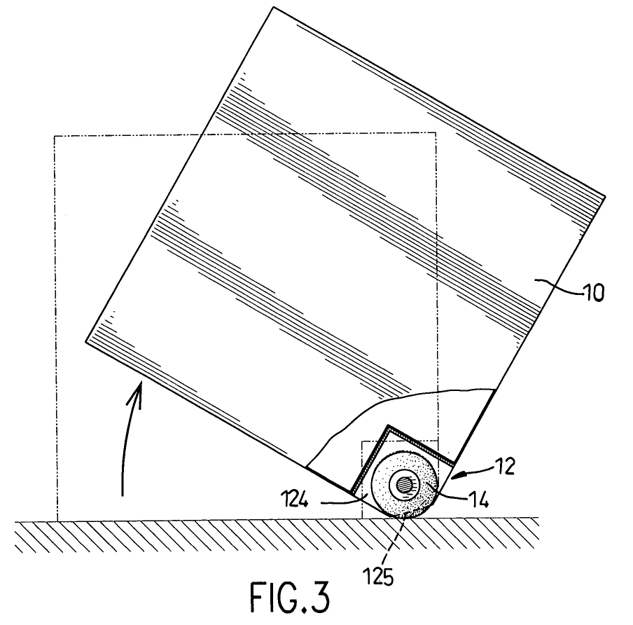

With further reference to FIG. 3, to transport the casing, one side of the body (10) is lifted to make parts of the wheels (14) exposed from the cutouts (125) in the wheel holders (12) abut against the ground. Consequently, the user can pull or push the casing to move. With the arrangement of the wheels (14), to transport the casing is easy and convenient even when the casing is filled with objects and is heavy. In addition, because the wheel holders (12) are received in the cavities (102) in the body (10), the volume of the entire casing with the wheel holders (12) and the wheels (14) will not increase.

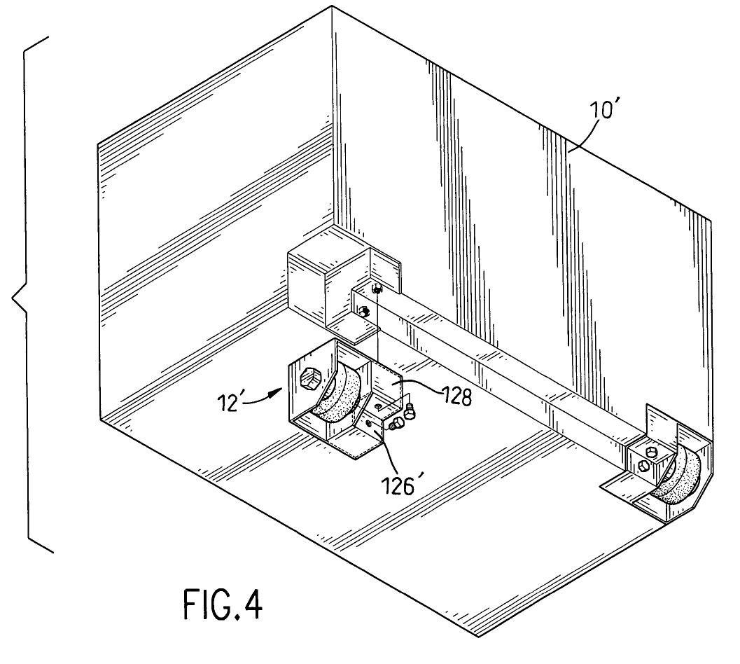

With reference to FIG. 4, a second embodiment of a casing in accordance with the present invention has a structure same as that of the first embodiment described previously, except that the securing frame (126′) on each wheel holder (12′) further has two ears (128). The ears extend respectively from two sides of the securing frame (126′) and abut against the body (10′).

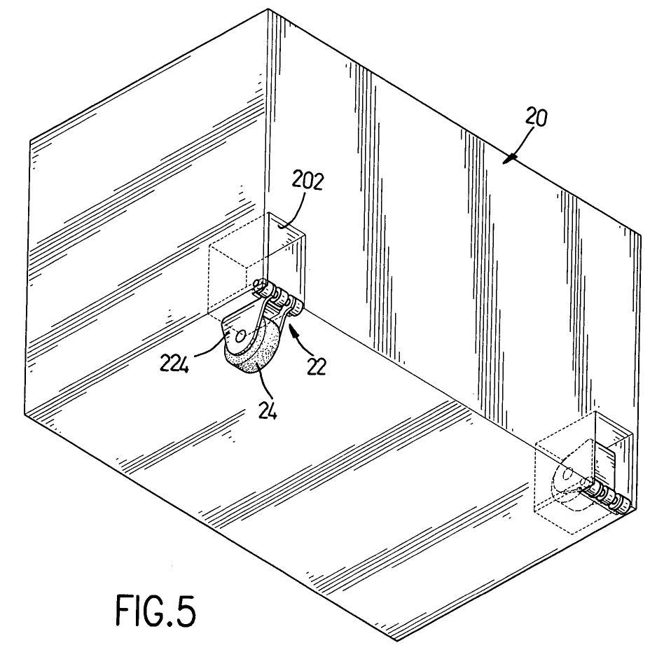

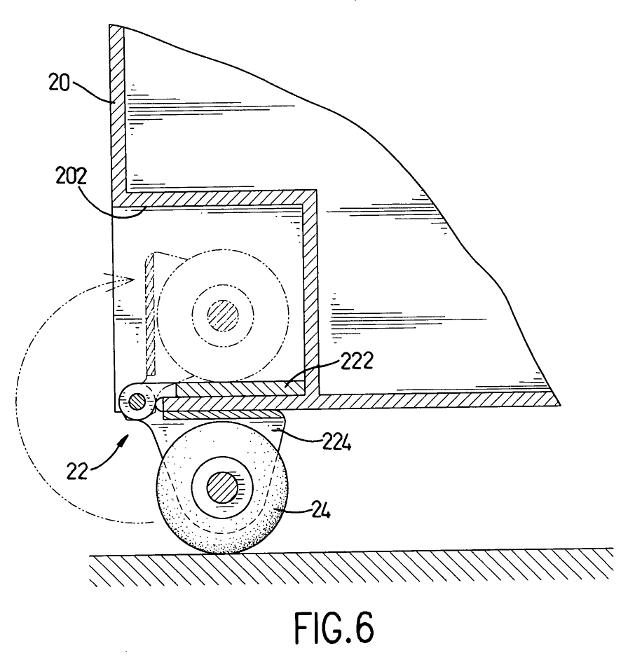

With reference to FIGS. 5 and 6, a third embodiment of a casing in accordance with the present invention comprises a hollow body (20), two wheel holders (22) and two wheels (24). The body (20) has two cavities (202) defined in one side the body (20) near the bottom. The wheel holders (22) are mounted respectively in the cavities (202), and each wheel holder (22) comprises a base (222) and a wheel mount (224). The base (222) is securely attached in a corresponding one of the cavities (202). The wheel mount (224) is inverse U-shaped with one end pivotally attached to the base (222), and each wheel (24) is rotatably mounted in one of the wheel mounts (224).

Before the casing is transported, the wheel mounts (224) with the wheels (24) are received in the cavities (202). When the user wants to move the casing, the wheel mounts (224) are pivotally rotated relative to the base (222) to escape from the cavities (202) in the body (20) and to abut against the bottom of the body (20) with the tops of the wheel mounts (224). Accordingly, the wheels (24) on the wheel mounts (224) will abut against the ground, such that the user can conveniently transport the casing at a low friction.

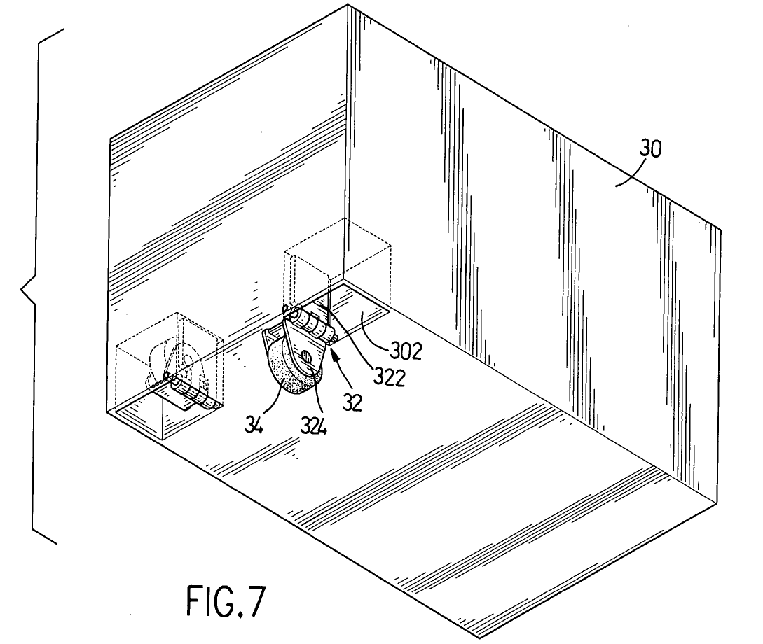

With reference to FIG. 7, a fourth embodiment of a casing in accordance with the present invention comprises a hollow body (30), two wheel holders (32) and two wheels (34). The body (30) has two cavities (302) defined in the bottom of the body (30). The wheel holders (32) are mounted respectively in the cavities (302), and each wheel holder (32) comprises a base (322) and a wheel mount (324). The base (322) is securely attached in a corresponding one of the cavities (302). The wheel mount (324) is inverse U-shaped with one side pivotally attached to the base (322), and each wheel (34) is rotatably mounted in one of the wheel mounts (324). The operation of the fourth embodiment is same as that of the third embodiment mentioned previously and is not further described.

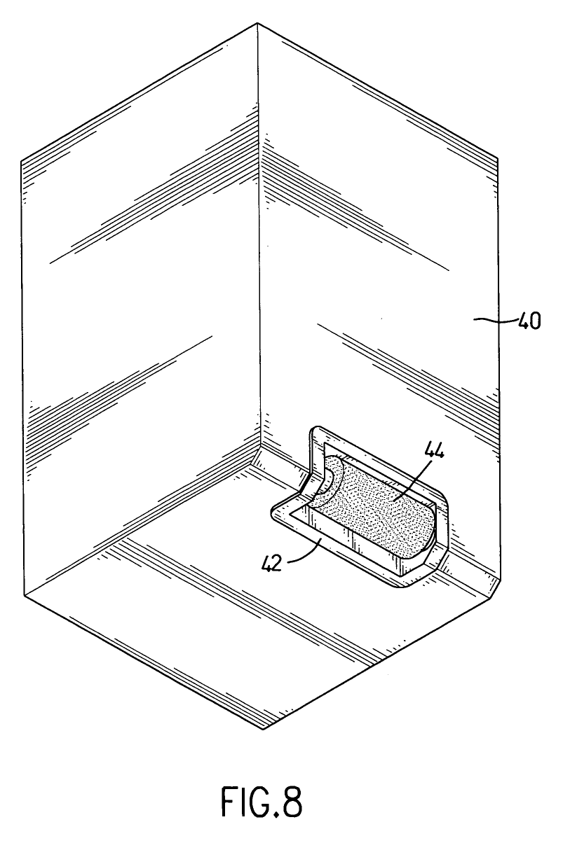

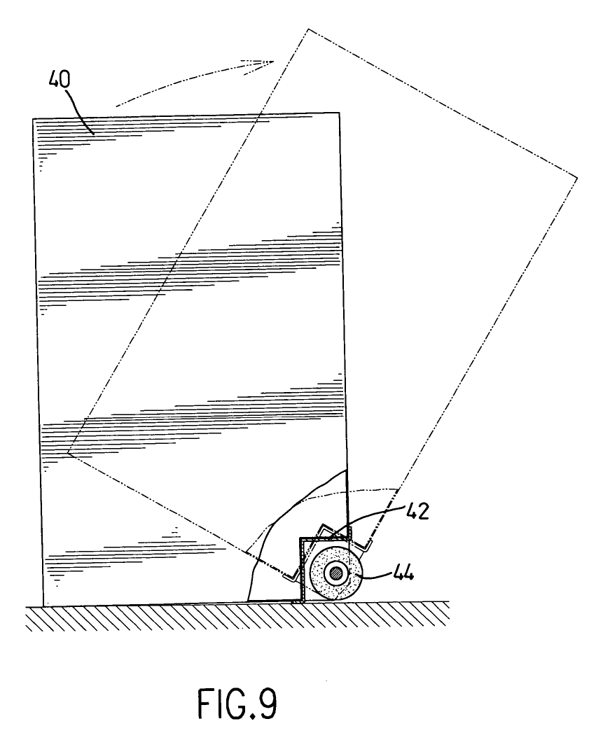

With reference to FIGS. 8 and 9, a fifth embodiment of a casing in accordance with the present invention comprises a body (40), a wheel holder (42) and a wheel (44). The body (40) has a cavity (not numbered) defined in one edge of the bottom. The wheel holder (42) is mounted in the cavity, and the wheel (44) is rotatably mounted in the wheel holder (42). The wheel (44) has a length greater than half of a length but smaller than the complete length of the edge on which the wheel holder (42) is mounted. To transport the casing with the wheel (44), one side of the body (40) is lifted to make the wheel (44) abut against the ground, such that the casing can be moved easily and conveniently.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A portable casing comprising:
a hollow body having at least one cavity defined in the body;
a wheel holder securely mounted in each respective one of the at least one cavity; and
a wheel rotatably mounted on each respective wheel holder.

2. The casing as claimed in claim 1, wherein the body has four sides, a bottom with four edges and four corners and two cavities defined respectively in adjacent corners of the bottom; and
two wheel holders are respectively mounted in the cavities.

3. The casing as claimed in claim 2, wherein each wheel holder has an L-shaped base with two sides and two wings extending from the sides of the base to define a space for receiving a wheel; and
each wing has a cutout to make the wheel exposed from the corresponding wheel holder.

4. The casing as claimed in claim 3, wherein a securing frame extends from one of the wings on each wheel holder and is securely attached to the body through fasteners.

5. The casing as claimed in claim 4, wherein each securing frame is L-shaped.

6. The casing as claimed in claim 5, wherein the securing frame on each wheel holder further has two ears respectively extending from two sides of the securing frame and abutting against the body.

7. The casing as claimed in claim 1, wherein the body has four sides, a bottom with four edges and four corners and two cavities defined in the body; and
two wheel holders mounted respectively in the cavities and each comprising:
a base securely attached in a corresponding one of the cavities; and
a wheel mount pivotally attached to the base for a wheel rotatably mounted in the wheel mount.

8. The casing as claimed in claim 7, wherein the cavities are defined in one side of the body near the bottom; and
each wheel mount is inverse U-shaped and has one end pivotally connected to the base.

9. The casing as claimed in claim 7, wherein the cavities are defined in the bottom of the body; and
each wheel mount is inverse U-shaped and has a side pivotally connected to the base.

10. The casing as claimed in claim 1, wherein the body has four sides, a bottom with four edges and four corners and a cavity defined in one edge of the bottom; and
a wheel holder is mounted in the cavity.

11. The casing as claimed in claim 10, wherein the wheel has a length larger than half of a length but smaller than a complete length of the edge on which the wheel holder is mounted.
